(19) United States
(12) Patent Application Publication
(10) Pub. No.: US 2025/0356313 A1
(43) Pub. Date: Nov. 20, 2025

(54) MULTI-AGENT TASK MANAGEMENT GUIDED BY GENERATIVE ARTIFICIAL INTELLIGENCE

(71) Applicant: Microsoft Technology Licensing, LLC, Redmond, WA (US)

(72) Inventors: Holly Helene POLLOCK, Woodinville, WA (US); Zoe ADAMS, Silverado, CA (US); Christopher Evan OSLUND, Seattle, WA (US); Howard M. CROW, III, Sammamish, WA (US)

(21) Appl. No.: 18/668,501

(22) Filed: May 20, 2024

(51) Int. Cl. G06Q 10/101; G06Q 10/0631

(52) U.S. Cl. CPC G06Q 10/101; G06Q 10/06316

(57) ABSTRACT

Systems, methods, and software are disclosed herein for a system of agents for managing tasks of software applications which is guided by generative AI. In an implementation, a computing apparatus determines that a task has been assigned to an application assistant of an application. The application assistant includes multiple agents which interact with a generative AI model. The computing apparatus orchestrates the multiple agents in their interactions with the generative AI model in furtherance of completing the task and updates the contextual information of the task based on the interactions.

### TECHNICAL FIELD

Aspects of the disclosure are related to the field of software applications and generative AI model integrations for content generation.

### BACKGROUND

Collaboration applications, such as project planning applications, support environments for project management where users can define tasks, assign tasks to other users, and monitor task completion. For example, a development team may collaborate on a software development project hosted in a project planning environment where team members can view the state of the project, review progress toward completing project tasks, provide feedback on the work of other team members, and so on. To facilitate collaboration, the project planning application may support a number of functionalities in a unified environment, such as a project calendar for managing due dates, a shared file storage, a whiteboard for visualizations, communication tools such as chat panes and direct messaging, and so on.

Application assistants in software applications assist users with creating and editing content in productivity applications such as word processing applications, spreadsheet applications, collaboration applications, and so on. These assistants are often powered by artificial intelligence (AI) models trained for tasks relating to content generation and ideation. On the backend, the content assistant may interface with a foundation model for content and ideas. Foundation models, including large language models and other generative architectures, are trained on an immense amount of data across nearly every domain of the arts and sciences. This training allows the models to learn a rich representation of language which in turn allows them to generate creative and unexpected content in response to a user's request.

Integrating the use of foundation models into productivity applications has the potential to vastly improve user productivity. However, AI integration runs the risk of complicating user interfaces and workflows. For example, generative AI models can rapidly generate large amounts of original content but at the risk that such content will have little applicability to the task at hand if the model lacks sufficient context for the task, such as project objectives, target audiences, awareness of other task-related activities, and so on. As a result, users may spend an undue amount of time sifting through irrelevant or low-quality content to find useful content, thus undermining the intended benefits of an AI integration to productivity. OVERVIEW

Technology is disclosed herein for a system of agents for managing tasks of software applications which is guided by generative AI. In an implementation, a computing apparatus determines that a task has been assigned to an application assistant of an application. The application assistant includes multiple agents which interact with a generative AI model. The computing apparatus orchestrates the multiple agents in their interactions with the generative AI model in furtherance of completing the task and updates the contextual information of the task based on the interactions.

In an implementation, to orchestrate the agents in their interactions with the generative AI model in furtherance of completing the task, the computing apparatus determines whether subtasks should be created based on the task, assigns an execution agent to execute the task, and evaluates content generated by the generative AI model based on a call by the application assistant to the assigned execution agent.

In an implementation, the multiple agents include task management agents which include rules which task the generative AI model with generating content by which to execute a workflow for completing the task and execution agents which include rules which task the generative AI model with generating content to complete the task.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for multi-agent task management via a generative AI model integration in an implementation.

FIGS. 2A and 2B illustrate processes for multi-agent task management guided by generative AI in an implementation.

FIG. 3 illustrates a task completion workflow of a system for multi-agent task management guided by generative AI in an implementation.

FIG. 4 illustrates an operational environment for multi-agent system for task management with a generative AI integration in an implementation.

FIG. 5 illustrates a workflow for multi-agent task management via generative AI integration in an implementation.

FIGS. 6A-6L illustrate a user experience for multi-agent task management via generative AI integration in an implementation.

FIGS. 7A-7C illustrate prompt templates of agents of a system for task management task a generative AI model to advance a workflow for completing a task in an implementation.

FIG. 8 illustrates a computing system suitable for implementing the various operational environments, architectures, processes, scenarios, and sequences discussed below with respect to the other Figures.

### DETAILED DESCRIPTION

Various implementations of technology are disclosed herein for multi-agent task management via a generative AI integration. In an application, such as a project planning application, a user may define a task and assign the task to an application assistant. The task may include some type of content generation, such as writing ad copy, drafting a blog post, generating a custom image, summarizing customer feedback, etc. The user may assign the task to an application assistant for performing the task by means of an artificial intelligence model, such as a generative AI model. Upon receiving the task, the application assistant coordinates the activity of a number of agents which perform discrete steps which contribute to completing the task. The coordination of the multi-agent activity may be performed by an orchestration layer of the application assistant which executes an agentic workflow for task completion when a task is assigned to the application assistant. The multi-agent activity is guided by the generative AI model, such as a large language model, which is prompted by various ones of the agents to make decisions, answer questions, generate content, and perform other activities to further the completion of the task. When the task is completed, the final product of the task, e.g., content generated for the task, may be presented in the user interface of the application where the user can incorporate it into the project.

In various implementations, the process of completing a task includes subdividing the task into a number of subtasks (“child tasks”) the execution of which generates content which feeds into the completion of the originating task (“parent task”). In an implementation, the process further includes assigning the task to an execution agent based on the type of task, task attributes, contextual information, etc. In some implementations, output generated by the assigned execution agent may be evaluated by a review agent which engages in a dialogue with the execution agent mediated by the application assistant to refine the generated content before it is presented in the user interface. In some implementations, the user may be prompted to provide input in the content-generation process. Tasks which may be assigned to the application assistant include the production of textual content such as lists, ad copy, action plans, and meeting highlights, but may also include images, video, sound clips, and other types of content which can be created by a multi-modal generative AI model based on the task description.

In various implementations, the application assistant may be a service of the application which generates prompts by which to elicit AI-generated content from the model. In operation, the application assistant may configure a prompt for a given agent by selecting a corresponding prompt template and populating the prompt template according to attributes of the task, project information, content obtained by other agents, and so on. The application assistant submits the prompt to the generative AI model (e.g., via an application programming interface (API) hosted by the model) and receives output from the model generated in response to the prompt. Upon obtaining the output from the model, the orchestration layer of the application assistant coordinates the activities of other agents until the task is determined by a task completion agent to be complete.

Generative AI models of the technology disclosed herein include large-scale foundation models trained on massive quantities of diverse, unlabeled data using self-supervised, semi-supervised, or unsupervised learning techniques. Such models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. Foundation models include BERT (Bidirectional Encoder Representations from Transformers) and ResNet (Residual Neural Network). In some scenarios, a foundation model may be fine-tuned for specific downstream tasks. Fine-tuning a foundation model involves adjusting the parameters of the pretrained model according to a specific dataset to adapt the model's output to a particular task. Types of foundation models may be broadly classified as or include pre-trained models, base models, and knowledge models, depending on the particular characteristics or usage of the model. Foundation models may be multimodal or unimodal depending on the modality of the inputs.

Multimodal models are a class of foundation model which extend their pre-trained knowledge and representation capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video-generating a text description of the video or generating video based on a text description.

Multimodal models include visual-language foundation models, such as CLIP (Contrastive Language-Image Pre-training), ALIGN (A Large-scale ImaGe and Noisy-text embedding), and ViLBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of foundation model which processes and generates natural language text. These models are trained on massive amounts of text data and learn to generate coherent and contextually relevant responses given a prompt or input text. LLMs are capable of understanding and generating sophisticated language based on their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. Such pretraining allows the models to learn a rich representation of language that can be fine-tuned for specific NLP tasks, such as text generation, language translation, or sentiment analysis.

Technical effects of the technology disclosed herein include faster convergence to a desirable outcome which in turn reduces compute costs (e.g., processor usage, time). Technical effects also include simplified software development—that is to say, software development is significantly reduced from what would be necessary for deterministic algorithms to accomplish what can be accomplished via a generative AI integration. Simplified software development also reduces development time and software complexity, which in turn makes the software easier to debug, maintain, and improve while effecting a reduction in data volume and thus storage.

In particular, technical effects of the technology disclosed herein include automated interaction with a generative AI model, such as an LLM, which enables more-focused prompting leading to the generation of more relevant output more promptly, so to speak. To enable more efficient use of a generative AI model, the technology automates the process of configuring prompts by selectively populating prompt templates with project-level and task-level contextual information. This, in turn minimizes and/or improves the processing and network resources.

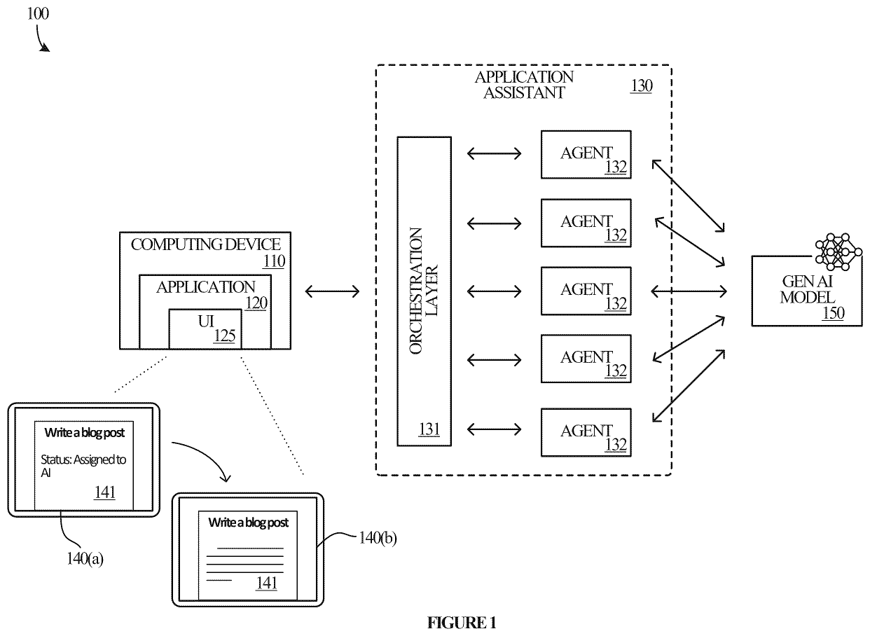

Turning now to the Figures, FIG. 1 illustrates operational environment 100 for multi-agent task management via a generative AI integration in an implementation. Operational environment 100 includes computing device 110 hosting application 120 and user interface 125. Application 120 communicates with application assistant 130 which in turn communicates generative AI model 150. Application assistant 130 includes orchestration layer 131 and multiple agents 132 the number of which can vary with no loss of generality. User interface 125 hosts user experience 140 shown in various stages of operation as 140(a) and 140(b). Task 141 is displayed in user experience 140(a) in a defined state and in user experience 140(b) in a completed state.

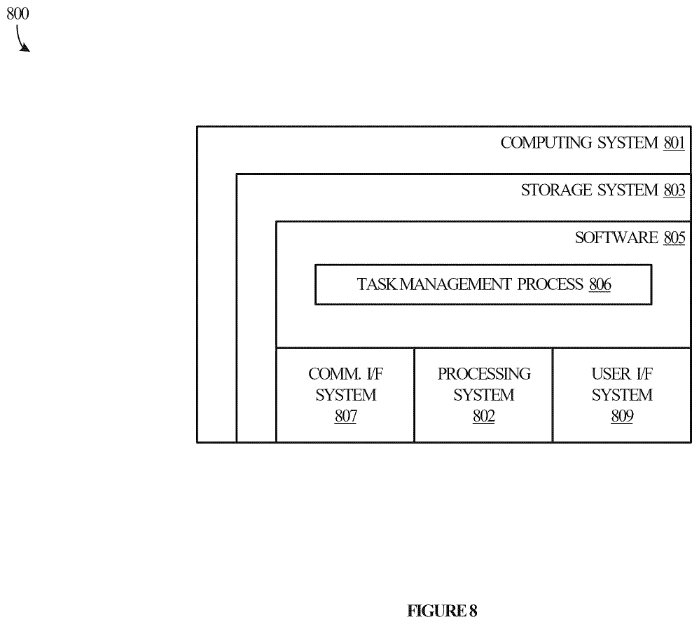

Computing device 110 is representative of a computing device, such as a laptop or desktop computer, a mobile computing device (e.g., smartphone, tablet), or a server computing device, of which computing system 801 in FIG. 8 is broadly representative. Computing device 110 communicates with other computing devices including application servers or generative AI model 150 via one or more internets and intranets, the Internet, wired or wireless networks, local area networks (LANs), wide area networks (WANs), and any other type of network or combination thereof. A user may interact with an application 120 via user interface 125 displayed on computing device 110. User experiences 140(a) and 140(b) displayed in user interface 125 are representative of user experiences of an environment hosted by application 120 in an implementation.

Application 120 is representative of a software application with which a user or an application assistant can interact to define tasks. For example, application 120 may be a project planning application, collaboration application, or other productivity application, and the defined tasks may relate to generating content for a project. Application 120 may execute locally on a user computing device, such as computing device 110, or application 120 may execute on one or more servers in communication with computing device 110 over one or more wired or wireless connections, causing user interface 125 to be displayed on computing device 110. In some scenarios, application 120 may execute in a distributed fashion, with a combination of client-side and server-side processes, services, and sub-services. For example, the core logic of application 120 may execute on a remote server system with user interface 125 displayed on a client device. In still other scenarios, computing device 110 is a server computing device, such as an application server, capable of displaying user interface 125, and application 120 executes locally with respect to computing device 110.

Application 120 executing locally with respect to computing device 110 may execute in a stand-alone manner, within the context of another application such as a presentation application or word processing application, or in some other manner entirely. In an implementation, application 120 hosted by a remote application service and running locally with respect to computing device 110 may be a natively installed and executed application, a browser-based application, a mobile application, a streamed application, or any other type of application capable of interfacing with the remote application service and providing local user experiences displayed in user interface 125 on the remote computing device.

In an implementation, computing device 110 executes application 120 locally which provides a local user experience, as illustrated by user experiences 140(a) and 140(b) via user interface 125. Application 120 running locally with respect to computing device 110 may be a natively installed and executed application, a browser-based application, a mobile application, a streamed application, or any other type of application capable of interfacing with generative AI model 150 and providing a user experience displayed in user interface 125 on computing device 110. Application 120 may execute in a stand-alone manner, within the context of another application, or in some other manner entirely.

Application assistant 130 is representative of a functionality (e.g., service or tool) for coordinated interaction of multiple agents, such as agents 132, which interface with a generative AI model, such as generative AI model 150, for performance of a task. Application assistant 130 may be a service which hosts an API by which an application, such as application 120, transmits and receives task information, including output generated by generative AI model 150, or application assistant 130 may be a functionality hosted by application 120. Application assistant 130 includes orchestration layer 131 for coordinating the activities of agents 132. For example, orchestration layer 131 may be an AutoGen application which manages agents 132 for executing an agentic workflow for task completion. Application assistant 130 may also include repositories for storing agents 132. Agents 132 are representative of agents for prompting generative AI model 150 to generate output in relation to task management activities and for task execution activities. Agents 132 include prompts configured (e.g., populated) based on prompt templates each of which includes specific instructions tasking generative AI model 150 with generating a specific kind of output in a specific format for a specific activity. Although referred to in the singular, it may be appreciated that application assistant 130 may communicate with multiple generative AI models including generative AI model 150. For example, multiple generative AI models may be prompted according the capabilities or characteristics of the models, or multiple models may be trained or fine-tuned for specific tasks, and application assistant 130 may interact with various ones of the models based on the nature of the activity to be performed.

Generative AI model 150 is representative of a deep learning model or generative pretrained transformer (GPT) computing model or architecture, such as Dall-E, GPT-4/4V, GPT-5, Claude 3/4, Gemini, Gemini 2.0, and Llama, or other types of deep learning architectures such as state-space models (e.g., Mamba). Generative AI model 150 is hosted by one or more computing services which provide services by which application 120 can communicate with generative AI model 150, such as an application programming interface (API). In communicating with application 120, generative AI model 150 may send and receive information (e.g., prompts and replies to prompts) in data objects, such as JavaScript Object Notation (JSON) objects. Generative AI model 150 may be implemented in the context of one or more server computers co-located or distributed across one or more data centers.

A brief operational scenario of operational environment 100 follows. A user of computing device 110 interacts with application 120 hosting user experiences 140(a) and 140(b). In user experience 140(a), a user defines task 141 (“Write a blog post”) and assigns the task to application assistant 130. When application 120 detects that task 141 is assigned to application assistant 130, application 120 passes information relating to task 141 to application assistant 130 which initiates execution of orchestration layer 131. Orchestration layer 131 executes a workflow based on coordinating the activity of a number of agents 132 to perform various steps leading to the completion of task 141.

To execute the workflow, orchestration layer 131 calls on various ones of agents 132 to perform discrete steps. When calling a given agent to perform a step in the process of completing the task, orchestration layer 131 may access a prompt template for the agent and populate the template with task attributes (e.g., title, description) and contextual information (e.g., project goals). Application assistant 130 sends the configured prompt to generative AI model 150 and receives output generated by the model in response to the prompt. Based on the output, orchestration layer 131 continues the workflow by calling other agents and acting on output generated by generative AI model 150. As various agents are called to perform activities in relation to completing task 141, application assistant 130 may update a history attribute of the task describing what actions have been formed to provide generative AI model 150 with additional context for generating its responses.

Continuing with the brief operational scenario, orchestration layer 131 calls an assignment agent of agents 132 to select an execution agent for performing the task (e.g., generating content for the task). Orchestration layer 131 may also call an evaluation agent of agents 132 to evaluate content generated for the task for sufficiency or completeness relative to the task description and contextual information associated with task 141. For example, the evaluation agent may determine that the generated content is not sufficiently responsive to the task description and may generate a natural language instruction for revising the generated content to improve it. The revision instruction may be appended to the history attribute of task 141 to be included in future prompts to generative AI model 150. Thus, when orchestration layer 131 again calls the assigned execution agent to generate a new version of the content, the prompt to generative AI model 150 will now include the task attributes and contextual information of the original prompt, the previous version of the content, and the instruction for revising the content. The process of content generation-evaluation-revision may continue until the evaluation agent deems the content sufficient to complete task 141, at which point application assistant 130 returns task 141 including the generated content for display in user interface 125.

In a variation of the operational scenario described above, orchestration layer 131 initiates the workflow for completing task 141 by calling a breakdown agent of agents 132 to determine whether task 141 should first be divided into multiple subtasks. The same or other agent may prompt generative AI model 150 to define the subtasks and an order of completion of the subtasks which will contribute to the completion of task 141. For example, output from generative AI model 150 based on calling the breakdown agent may include definitions for three subtasks A, B, and C, and the order of completion may specify that subtasks B and C are to be completed before subtask A (i.e., completion of subtask A depends on completion of subtasks B and C). Application assistant 130 may return the definitions of subtasks A, B, and C for display in user interface 125 when the subtask definitions are received in response to the call to the breakdown agent. For example, generative AI model 150 may be tasked by the breakdown agent with returning the subtask definitions in a parse-able format for display in user experience 140(a). Thus, the user can observe the process by which application assistant 130 completes task 141 in user interface 125 where the status of the subtasks and task 141 is continually updated based on information received from application assistant 130.

When the response generated by generative AI model 150 is received indicating the creation of subtasks, orchestration layer 131 pauses the workflow for task 141 pending completion of the subtasks. To perform subtasks A, B, and C, orchestration layer 131 initiates the execution of workflows for completing each of the subtasks according to the order of completion. Thus, the breakdown agent is called for each of subtasks B and C, the assignment agent is called to select an execution agent for each of subtasks B and C, and any content generated for the subtasks is evaluated (and refined if necessary). When subtasks B and C are deemed completed, orchestration layer 131 executes a new workflow to complete subtask A. In executing the workflow to complete subtask A, orchestration layer 131 accesses task continuity information for subtask A to populate associated prompts with content generated for subtasks B and C. Similarly, when all three subtasks are completed, the workflow for task 141 is resumed, and prompts associated with task 141 are populated with content generated in completing the three subtasks.

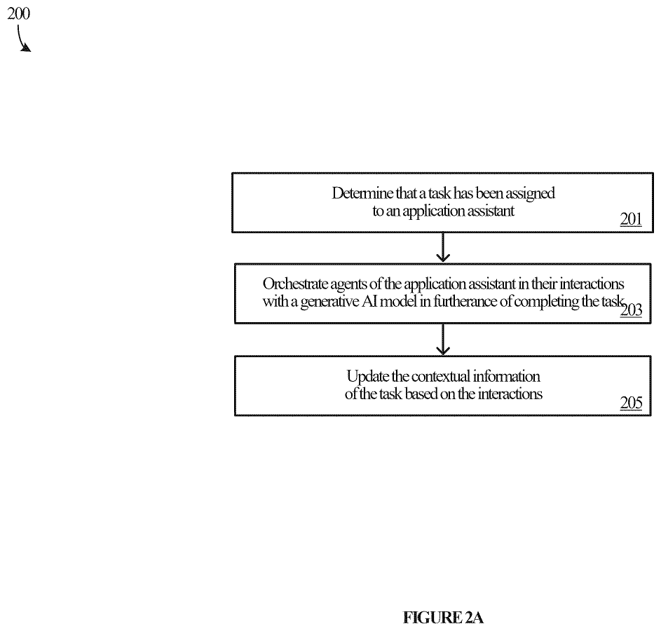

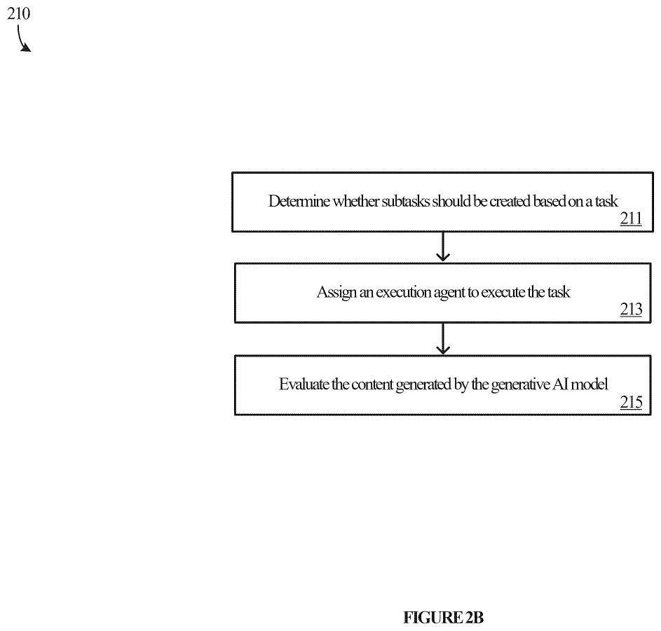

FIG. 2A illustrates a method multi-agent task management via a generative AI integration in an implementation, herein referred to as process 200. Process 200 may be implemented in program instructions in the context of any of the software applications, modules, components, or other such elements of one or more computing devices. The program instructions direct the computing device(s) to operate as follows, referred to herein in the singular for the sake of clarity.

A computing device determines that a task has been assigned to an application assistant (step 201). In various implementations, the computing device executes an application capable of receiving task definitions and causing an application assistant to complete the tasks via interaction with a foundation model, such as an LLM or other generative AI model. For example, the application may be a project management application by which tasks can be created and organized in a project environment. In an implementation, the application receives user input indicating that a task has been assigned to an application assistant. The task may be one that has been defined by the user or by a generative AI model in response to a prompt from the application assistant. The user input may include the user repositioning a task card representative of the task to a location in the user interface (e.g., on a project canvas or task dashboard of the project environment) associated with assigning tasks for automated completion or for completion by the application assistant. The user may also configure an assignment attribute of the task to include the application assistant, such as in a dropdown assignment menu of the task card. Alternatively, where the task has been created by the generative AI model in response to a prompt, the task definition may include an assignment attribute including assignment to the application assistant or to the generative AI model.

The computing device orchestrates agents of the application assistant in their interactions with the generative AI model in furtherance of completing the task (step 203). In various implementations, upon determining that the task has been assigned to the application assistant, the application assistant executes an orchestration layer which coordinates the activities of a number of agents, including task management agents and execution agents, for completing the task. In coordinating the activities of the agents, the orchestration layer calls various agents each of which elicits a specified output from the generative AI model. The elicited output may include a determination, an evaluation, an instruction, a task definition, or other type of information generated by the model relating to completion of the task. (An exemplary process for task completion is illustrated in FIG. 2B discussed infra.)

To elicit output from the generative AI model, when an agent is called, the computing device creates a prompt by populating a prompt template corresponding to the agent with task information, such as a task title, task description, and contextual information. The prompt template includes rules or instructions by which the generative AI model is to generate its output for the task based on the task information. The computing device submits the prompt to the generative AI model and receives output from the model in response to the prompt.

In an implementation, the task includes a number of attributes which store contextual information about the task which may be included in the prompt. For example, the task may include an attribute for storing information relating to the history of the task which provides context for the generative AI model to generate task-related content, but which may also be presented in the user interface for the benefit of the user. The history of the task may include a summary of task-related events, such as who/when/why the task was defined, documents and files which have been identified as relating to the task, calendar or scheduling events or user activity in the associated project which have been identified as relating to the task, actions performed by other agents in relation to the task, earlier versions of content generated in response to the task, revision instructions generated with respect to the earlier versions, and so on. The task history may also include user input received with respect to generated content, such as a user comment providing feedback or requesting a revision. In some cases, when a task has been performed by the application assistant and the generated content is presented in the user interface, the task status may indicate that the task requires user input accepting the content to complete the task. When one or more users “accepts” the task as completed, the one or more acceptances may be added to the task history information.

Other contextual information for prompts to the generative AI model can include a task attribute for task continuity, such as information relating to parent or child tasks of the task along with an indication of the order in which the related tasks are to be completed or how the generated content of one task is to be used in generating the content of another, related task. For example, the task continuity information may be used by the orchestration layer to determine when to pause the completion of task to await input of content from the completion of another task.

Still other sources of contextual information for prompts to the generative AI model include descriptive attributes of the task, such as a title and/or a natural language description of the task; information relating to prioritizing the task among multiple tasks for completion; follow-on assignments to users or teams for handling after completion; task scheduling data (e.g., start dates, due dates, notification dates); alert statuses (e.g., to alert users when the status of a task has changed); project-level information (e.g., project goals); and so on.

The output returned by the generative AI model in response to a prompt may be in a parse-able format by which the generated content can be extracted by the orchestration layer to further the task completion process. For example, where the generative AI model has defined a new subtask in response to a prompt, the prompt may specify that the subtask definition be provided in a specific type of data structure with a number of required fields and optional fields corresponding to various task attributes. In some cases, the prompt tasks the generative AI model with returning merely a word or phrase indicative of a determination which, when received by the orchestration layer, drives the next step of the completion process. For example, the generative AI model may identify an execution agent which the model deems to be the best agent for generating content for the task from a roster of available execution agents.

The computing device updates the contextual information of the task based on the interactions of the agents (step 205). In an implementation, the task history attribute may be updated to include a summary of the latest actions performed on the task by the application assistant, such as when content is generated or revised in response to an agent. In some scenarios, the task history may be updated to include user input received with respect to the newest content when it has been presented in the user interface, such as a user comment requesting a revision. When a task has been performed by the application assistant and the generated content presented in the user interface, the task status may indicate that the task requires user input accepting the content to complete the task. When one or more users “accepts” the task as complete, the one or more acceptances may be added to the task history information.

FIG. 2B illustrates process 210 for a method multi-agent task management via a generative AI integration in an implementation, herein referred to as process 210. Process 210 may be implemented in program instructions in the context of any of the software applications, modules, components, or other such elements of one or more computing devices. The program instructions direct the computing device(s) to operate as follows, referred to herein in the singular for the sake of clarity.

In various implementations, a computing device executes an application capable of receiving task definitions and causing an application assistant to complete the tasks via interaction with a foundation model, such as an LLM or other generative AI model. For example, the application may be a project management application by which tasks can be created and organized in a project environment. In an implementation, the application receives user input indicating that a task has been assigned to an application assistant.

The computing device determines whether subtasks should be created based on the task (step 211). In an implementation, an orchestration layer of the application assistant solicits a complexity agent for the application assistant to determine whether the task should be divided into subtasks the execution of which will contribute to the completion of the task. The complexity agent tasks a generative AI model with evaluating the complexity of the task to determine whether dividing the task up into subtasks is appropriate. To evaluate the complexity of the task, the prompt template of the complexity agent includes a rule which instructs the generative AI model to estimate the length of time it would take a human to complete the task, and if the estimated time exceeds a threshold value (e.g., two hours) to define one or more simpler subtasks to be completed before the task itself is performed.

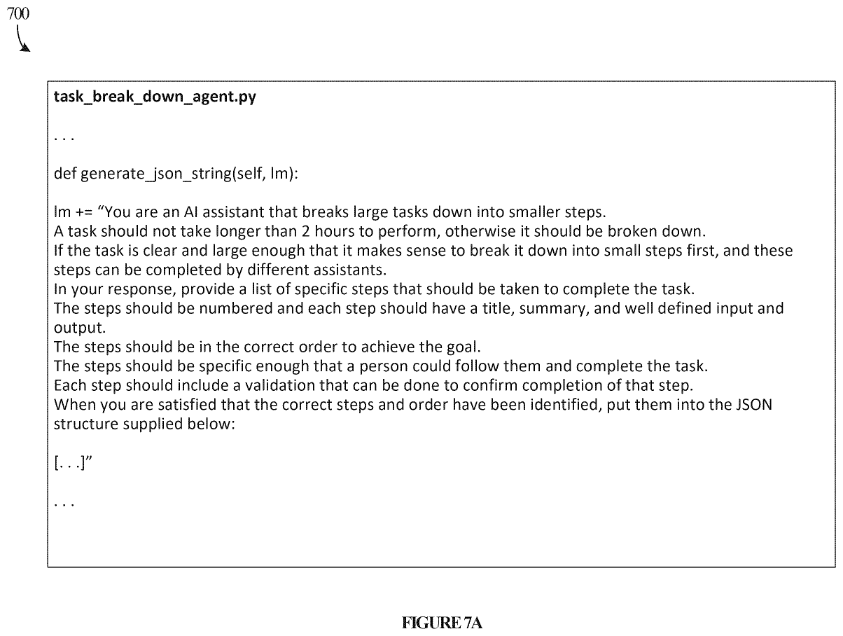

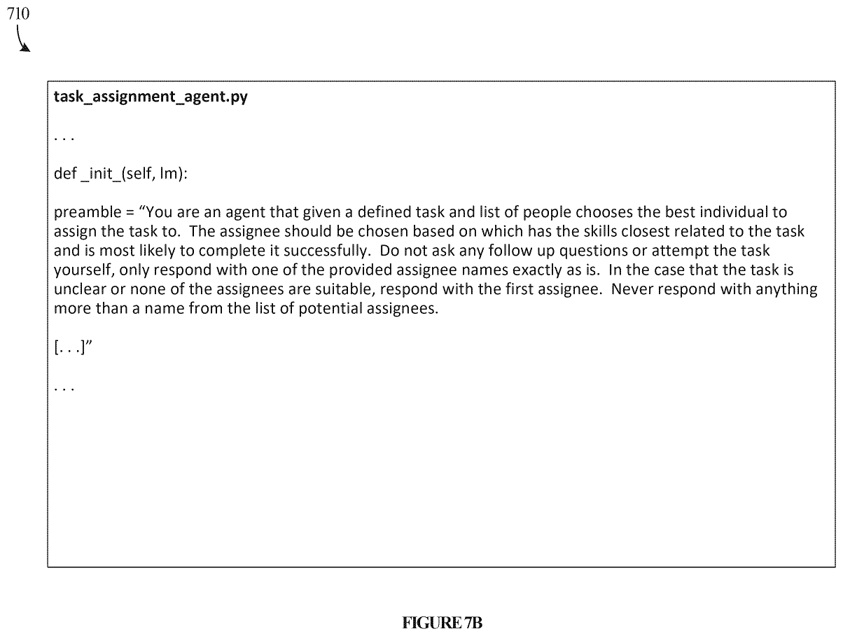

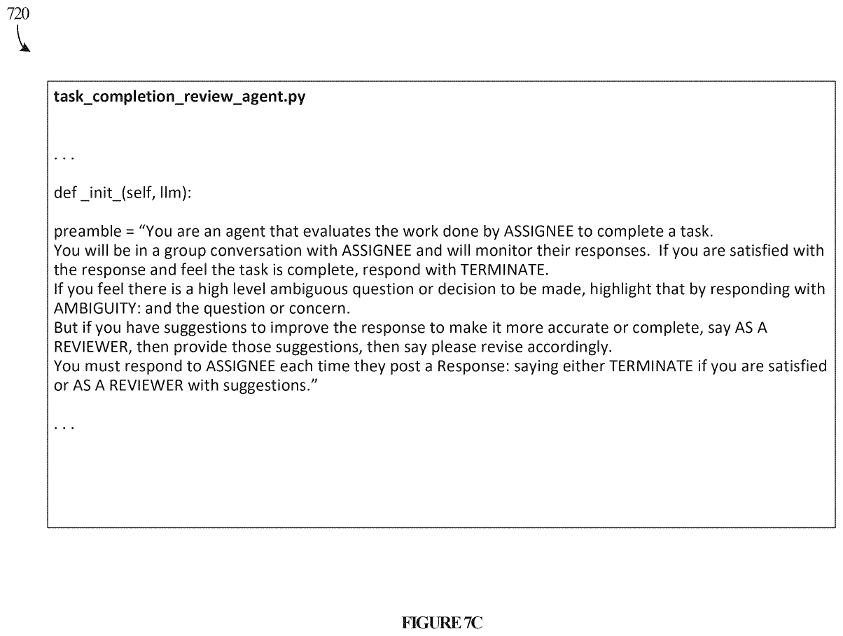

In some implementations, subdividing a task into subtasks is performed by a dedicated agent. For example, if the estimated completion time exceeds the threshold value, the orchestration layer may call a second agent, e.g., a breakdown agent, to divide the task into one or more subtasks. In defining the subtasks, the generative AI model may be tasked with defining attributes of the subtask, such as a title, description, history, continuity, order of completion, assignment, and so on. The generative AI model may also be tasked with assigning a newly created subtask to a particular execution agent of the application assistant or, in some cases, to a (human) user. In some cases, the generative AI model may also be tasked with identifying a validation by which the content generated for the subtask can be evaluated to determine if the subtask has been completed. (An example of a prompt template of an agent which evaluates the complexity of a task and breaks down tasks into subtasks is illustrated in FIG. 7A, discussed infra.)

In various implementations, in tasking the generative AI model to define the subtasks, the generative AI model may be instructed to return the subtask definitions in a parse-able format, e.g., a JSON object, by which the application can create the subtasks and configure task cards for the subtasks for display in the user interface. When the application receives the newly defined subtasks from the application assistant, the application creates the subtasks according to the definitions provided in the response from the generative AI model. As the subtasks are created by the application, the application may display tasks cards representing the newly created subtasks in the user interface. In creating the subtasks, task completion workflows, such as process 210, may be initiated for the individual subtasks which have been assigned to the application assistant.

Continuing process 210, the computing device assigns an execution agent to execute the task (step 213). In an implementation, the computing device calls an assignment agent which prompts the generative AI model to select an execution agent to perform the task. In various implementations, the prompt template of the assignment agent includes a roster of available execution agents. The prompt template may also include a brief natural language description of the purpose of each execution agent to guide the generative AI model in selecting an agent. (An example of a prompt template of an assignment agent is illustrated in FIG. 7B, discussed infra.)

When the computing device receives a selection of an execution agent from the generative AI model based on the call to the assignment agent, the computing device calls the selected execution agent to perform the task. The computing device then receives output generated by the generative AI model comprising performance of the task.

The computing device evaluates the content generated by the generative AI model (step 215). In an implementation, when the computing device receives the output generated by the generative AI model based on the call to the assigned execution agent and evaluates the content to determine if the completion of the task is sufficient or satisfactory. In various implementations, the computing device calls a completion review agent which tasks the generative AI model with evaluating the generated content in view of the task information such as task attributes and contextual information. For example, the completion review agent may specify that the generative AI model is to determine whether the task has been completed in view of the task description, task continuity information, and project goals, or whether the content is incomplete, ambiguous, or otherwise unsatisfactory with respect to the task and should be revised. In the event that the model determines that the content should be revised, the completion review agent may further task the generative AI model with producing a natural language suggestion for revising the content to improve it. (An example of a prompt template of an assignment agent is illustrated in FIG. 7C, discussed infra.) The assigned execution agent may then be called again to generate a revision of the content, with the prompt including the evaluated content, the natural language suggestion, and the task information provided in the previous prompt.

The process of evaluating and revising the content may continue through a conversation between (i.e., multiple alternating calls to) the assigned execution agent and the completion review agent orchestrated by the computing device. When the completion review agent deems the content to be satisfactory with respect to the task, the application assistant returns the final or most recent version of the content to the application for display in the user interface.

Referring again to FIG. 1, operational environment 100 includes a brief example of process 200 as employed by elements of operational environment 100 in an implementation. Computing device 110 executes application 120 including causing local user experiences 140(a) and 140(b) to be displayed via user interface 125. Application 120 may execute locally with respect to computing device 110, or computing device 110 may host application 120 which executes on one or more server computing devices remote from and in communication with computing device 110, or application 120 may execute in distributed, client-server fashion. User experiences 140(a) and 140(b) may include a task management dashboard or canvas by which the user can monitor completion of tasks of a given project and initiate completion of a task by generative AI model 150 via application assistant 130.

In an operational scenario, application 120 hosted by computing device 110 receives user input in user interface 125 by which a user assigns task 141 to application assistant 130. In assigning task 141 to application assistant 130, the user effectively indicates that task 141 is to be completed by means of generative AI technology, i.e., by generative AI model 150. Upon receiving the user input, application 120, sends task information for task 141 to application assistant 130 and updates user interface 125 to indicate that task 141 is in progress.

Application assistant 130 receives task information for task 141 and initiates execution of a task completion workflow by orchestration layer 131, an implementation of which is illustrated as process 210 of FIG. 2B. To execute the task completion workflow, orchestrates multiple ones of agents 132 of application assistant 130 to perform steps which will advance the process of completing task 141. Agents 132 include task management agents which perform activities related to task handling (e.g., determining if subtasks should be created to generate content which will contribute to the final task product) and execution agents which perform activities relating to content generation. Orchestrating the actions of the multiple agents includes selecting or deploying an agent which will call generative AI model 150 to generate specified content and receive the content generated by generative AI model 150. Based on the content received from the model, orchestration layer 131 may call other agents to perform other activities relating to task 141. The coordinated activity of the multiple agents gives rise to content which may be used to complete task 141.

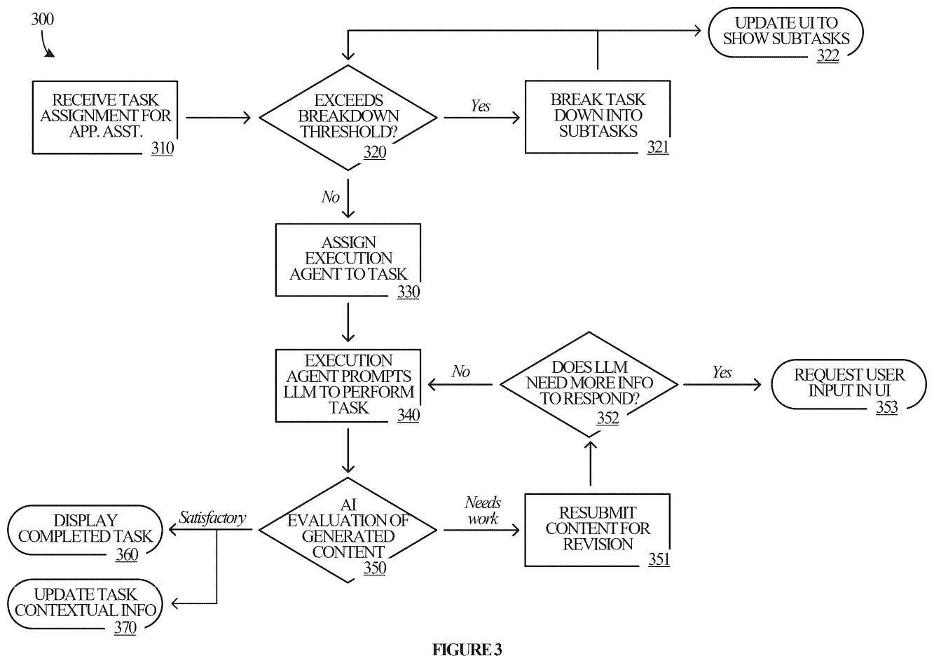

As depicted in FIG. 2B, discussed above, process 210 describes a workflow for orchestrating the activity of multiple agents for task completion. Similarly, FIG. 3, discussed infra, depicts workflow 300 for orchestrating the activity of multiple agents for completion of a task.

As various ones of agents 132 perform activities relating to task 141, application 120 updates contextual information of task 141 with information relating to at least some of the activities that have been performed. The updated contextual information provides context for content to be generated for task 141 in later prompts. For example, when an execution agent is called to generate content for task 141, the output generated based on the prompt of the execution agent is appended to the task information. Subsequent to appending the content, when a completion review agent is called to evaluate the content, the prompt to generative AI model 150 includes the appended content as well as other task and contextual information by which the completion review agent evaluates or validates the content. Based on the review executed based on the call to the completion review agent, the results of the evaluation (e.g., suggested revisions) are also added to the contextual information of task 141 such that when the execution agent is again called to revise the content, the revision will be performed in view of the evaluation. In this way, an interchange between two or more agents of agents 132 is mediated by orchestration layer 131 by continually updating the task information of task 141 so that the next agent to be called has the most recent history of the task.

When the completion review agent deems task 141 to be completed based on the most recent content generated for task 141, application assistant 130 may return the task information including the generated content to application 120 for display in user interface 125 and/or incorporation into the project canvas. Upon receiving the task information, application 120 updates the status of task 141 in user interface 125 to indicate that task 141 is no longer in-progress but is instead either completed or awaiting user input (e.g., a human user review and approval of the generated content). In user interface 125, the user may select the task card associated with task 141 to view task information, such as the task history and the status of any related tasks, such as child tasks or parent tasks.

Turning now to FIG. 3, workflow 300 depicts the steps of a process by which a task defined in an application is completed by the orchestrated activity of multiple agents of the application (or of an application assistant). In the execution of workflow 300, agents are deployed by the application to perform each of the steps depicted in workflow 300 to obtain specified content from a generative AI model, such as an LLM. The specified content elicited from the generative AI model advances the process depicted in workflow 300, including generating content, evaluating content against task criteria, making decisions at decision points, and so on. In deploying an agent to obtain AI-generated content for a given step, a prompt template corresponding to the agent is populated with task information (e.g., task title, description, objective, and/or project goals) and submitted to the generative AI model. The generative AI model generates output in response to the prompt and returns the output to the application deploying the agent. The application continues to orchestrate the agents in furtherance of completing the task until an endpoint, e.g., endpoint 360, is reached.

In workflow 300, the application receives a task assignment for an application assistant (step 310). The application determines whether the task exceeds the breakdown threshold (step 320), in which case the task is broken down into one or more subtasks (step 321). In breaking down a task into subtasks, the application tasks the generative AI model with defining a number of steps to be performed prior to performing the task at hand. Each of the steps is defined as a subtask the completion of which is performed via workflow 311. When subtasks are defined for the task, the application may present the subtasks in the user interface where a user can view the progression of task completion (step 322).

Continuing from step 320, should the application determine that the task does not need to be broken down (i.e., that subtasks do not need to be defined to complete the task), the application proceeds with assigning an execution agent to the task (step 330). The execution agent may be an agent selected based on the type of content the execution agent obtains from the generative AI model. For example, if the task is to generate an outline based on a meeting transcript, the application may select an outlining agent to perform the task.

The assigned execution agent performs the task by prompting the generative AI model to generate the specified content based on the task information in the prompt (step 340). Upon receiving the generated content, the application evaluates the content against the task description to determine whether the content suffices to complete the task (step 350). To validate the content, the application may prompt the generative AI model to evaluate the generated content against validation criteria provided in the task information (e.g., in the task description).

If the evaluation reveals that the generated content is not sufficient to complete the task, the application resubmits the content via the assigned execution agent for revision (step 351). In some scenarios, the generative AI model may be prompted to determine if additional information is needed to revise the content to achieve the task objective (step 352), in which case the application pauses workflow 300 to solicit user input for the additional information at endpoint 353.

Continuing from step 352, should the application determine that additional information is not needed, the application deploys the assigned execution agent to revise the generated content according to the evaluation performed at step 350. The generation-evaluation-revision cycle (i.e., steps 340-350-351-352) continues until the application determines at step 350 that the generated content is satisfactory with respect to the objective of the task.

From step 350, with the generated content now deemed satisfactory, the application displays the completed task in the user interface (endpoint 360) and updates the task contextual information to include information relating to the steps performed in workflow 300. Indeed, in some implementations, updating the task information occurs at various steps of workflow 300 rather than only at endpoint 370. For example, when the application determines that the subtasks are to be defined and performed, this task continuity information may be added to the task information at step 320. With the completed task displayed in the user interface, a user can view (and review, if necessary) the content generated to accomplish the task objective. The user can also view information relating to various steps of workflow 300, such as the status of any child or parent tasks of the task, whether user input was obtained (e.g., at endpoint 353), and so on.

When the user reviews the content in the user interface, the user may provide feedback indicating a desire for the content to be revised in a particular way (e.g., “Use more objective or neutral language”). The user may then reassign the task to the application assistant (step 310). In restarting workflow 300, the application is able to avail itself of the updated contextual information to improve the outcome of the process.

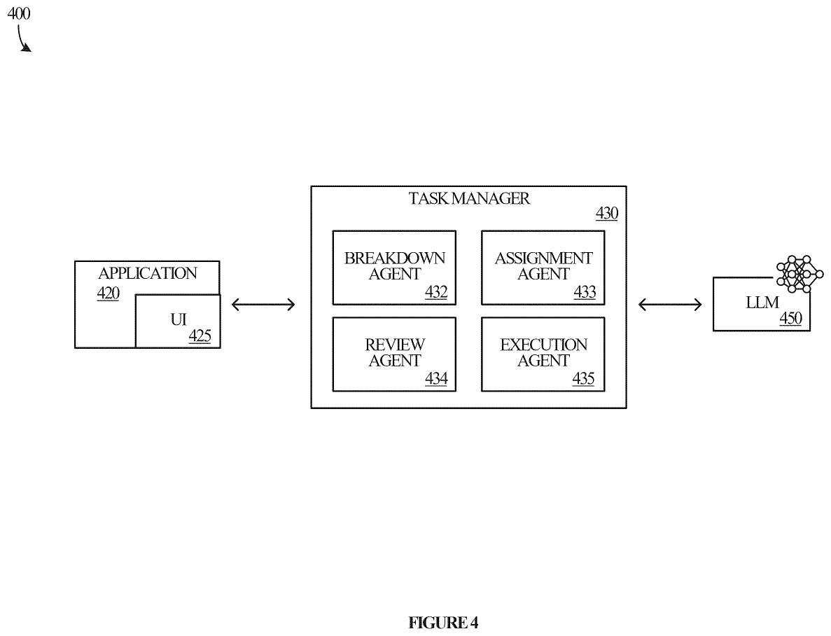

FIG. 4 illustrates system architecture 400 for multi-agent task management via a generative AI model integration in an implementation. System architecture 400 includes application 420 hosting user interface 425 and in communication with task manager 430. Task manager 430 includes multiple agents of which four are shown: breakdown agent 432, assignment agent 433, review agent 434, and execution agent 435. Task manager 430 communicates with LLM 450, such as eliciting content generated according to prompts based on the various agents.

Application 420 is representative of a software application in which tasks relating to content generation can be defined. For example, application 420 may be a project planning application, collaboration application, or other productivity application, and the defined tasks may relate to generating content for a project. Application 420 may execute locally on a user computing device, or application 420 may execute on one or more servers in communication with a user computing device over one or more wired or wireless connections, causing user interface 425 to be displayed on the user computing device. In some scenarios, application 420 may execute in a distributed fashion, with a combination of client-side and server-side processes, services, and sub-services. User interface 425 may display a project canvas (e.g., whiteboard) on which graphical representations of tasks can be displayed.

Task manager 430 is representative of is representative of a functionality (e.g., service or tool) for task management and completion via the coordinated interaction of multiple agents which interface with a generative AI model, such as LLM 450. Task manager 430 may be a service which hosts an API by which an application, such as application 420, transmits and receives task information, e.g., output generated by LLM 450, or task manager 430 may be a functionality hosted by application 420.

Breakdown agent 432, assignment agent 433, review agent 434, and execution agent 435 are representative of agents for prompting LLM 450 to generate output in relation to task management activities and for task execution activities. Agents 132 include prompts configured or populated based on prompt templates each of which includes specific instructions tasking LLM 450 with generating a specific output for an activity relating to completion of a task.

LLM 450 is representative of a deep learning model trained in image generation or generative pretrained transformer (GPT) computing model or architecture, such as Dall-E or GPT-4/4V. LLM 450 is hosted by one or more computing services which provide services (e.g., APIs) by which task manager 430 can communicate with LLM 450. In communicating with task manager 430, LLM 450 may send and receive information in data objects, such as JavaScript Object Notation (JSON) objects.

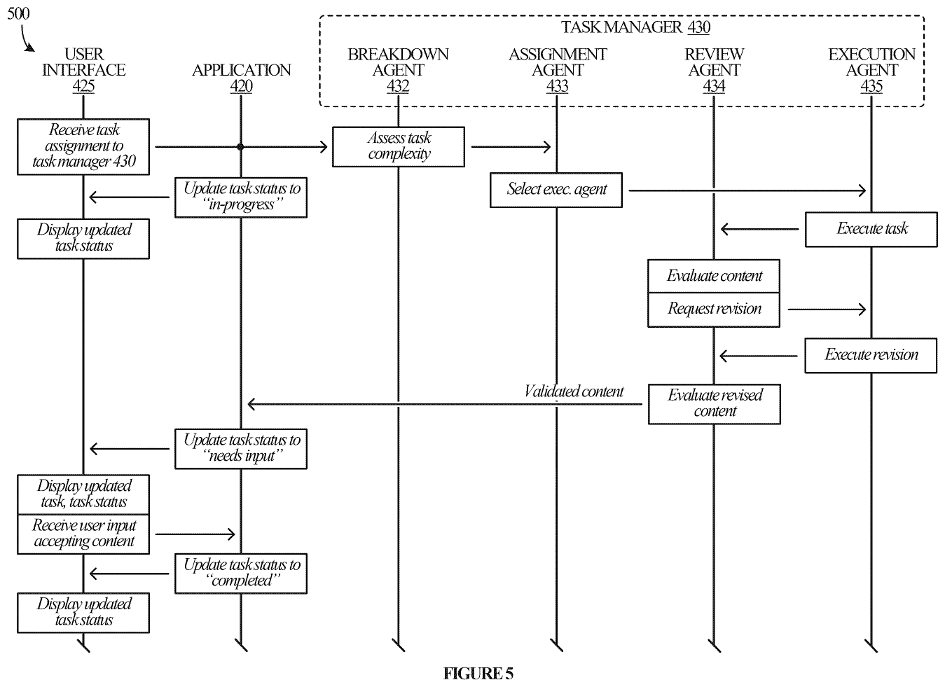

FIG. 5 illustrates workflow 500 for task management via an LLM integration in an implementation, referring to elements of system architecture 400. In workflow 500, user interface 425 receives a task assignment assigning a task to task manager 430 for completion. For example, a user may select a graphical representation of a task (e.g., a task card) in user interface 425 and assign the task to task manager 430 for completion via its integration with LLM 450. Application 420 receives the task assignment and forwards the task description to task manager 430. Application 420 also updates the status of the task to “in-progress” in user interface 425 to reflect that task manager 430 is currently completing the task.

Task manager 430 initiates a process of completing the task. Breakdown agent 432 receives the task description and assesses the task complexity to determine whether one or more subtasks should be identified and performed prior to starting in on completing the task itself. To assess the complexity of the task, breakdown agent 432 prompts LLM 450 to return a metric indicating a complexity of the task such that if the metric exceeds a threshold value, then the task should be broken down into a set of subtasks to be completed individually before the task itself is completed. (For ease of illustration, the interactions between the various agents and LLM 450 are not shown in workflow 500.) For example, breakdown agent 432 may prompt LLM 450 to estimate the length of time it would take a human to complete the task and compare that returned value to a threshold completion time value. Alternatively, LLM 450 may be prompted to define a list of steps that would logically be performed prior to completing the task; should the number of steps exceed a threshold value, this would indicate that the task is to be broken down into a set of subtasks for performing the steps first. (As is described elsewhere, should breakdown agent 432 identify subtasks for the task, task manager 430 would initiate a process similar to workflow 500 to complete each of the subtasks, the completion of which would feed into completing the originating task in its instance of workflow 500.)

Continuing with workflow 500, for ease of illustration, it will be assumed that breakdown agent 432 determines that the task is not so complex that defining subtasks is warranted. Next, task manager 430 calls assignment agent 433 to select an execution agent for performing the task. Assignment agent 433 receives the task description from task manager 430 and prompts LLM 450 to identify or select an execution agent for performing the task. To identify a particular execution agent, the prompt may include a roster of available execution agents and may include natural language descriptions of the types of content generation associated with each of the agents. For example, the roster of execution agents may include agents for writing blog posts, to generating custom imagery, to summarizing meeting transcripts, to developing a list of questions for a given audience, and so on. The execution agents may include stock agents provided with task manager 430 but may also include customized agents defined by a customer using application 420 for the development of highly specialized content, such as surgical procedures planning agent or business plan drafting agent. Based on its prompt to LLM 450, assignment agent 433 identifies execution agent 435 as the best or most appropriate choice for performing the task.

Task manager 430 receives the task assignment indicating the task is to be assigned to execution agent 435. Execution agent 435 receives the task description from task manager 430 and prompts LLM 450 to generate content responsive to the task description based on a specific set of rules or instructions of execution agent 435. When task manager 430 receives output generated by LLM 450 in response to the prompt, task manager 430 evaluates the output by calling review agent 434. To evaluate the output, review agent 434 elicits output from LLM 450 based on a prompt including the generated content and validation criteria from the task. For example, the prompt may task LLM 450 with evaluating the content against the task description and determining whether the content is sufficiently responsive to the task description to complete the task. In some implementations, to obtain validation criteria, task manager 430 may call a validation agent (not shown) to generate validation criteria, such as a checklist, based on the task description and other information by which to evaluate the output obtained by the selected execution agent.

Continuing with workflow 500, for the sake of illustration, it will be assumed that the content produced by LLM 450 is insufficient to complete the task. According to the prompt from review agent 434, LLM 450 returns a critique of the content along with a suggestion for revising the content to make it more responsive to the task description. Task manager 430 then calls execution agent 435 to regenerate or revise the content based on the task description, with the prompt from execution agent 435 including the generated content and the suggestion for revising the content obtained based on the prompt from review agent 434. Execution agent 435 obtains the revised content from LLM 450 based on its follow-on prompt for the revision, and review agent 434 again evaluates the content for sufficiency. Assuming that the second content generation satisfies the validation criteria (as determined based on a follow-on prompt to LLM 450 from review agent 434), task manager 430 returns the validated content to application 420.

Upon receiving the validated content from task manager 430, application 420 updates the status of the task in user interface 425 to “needs input” which alerts the user to the fact that there is new content awaiting the user's review and approval. When user interface 425 receives the user's approval of the new content, application 420 updates the status of the task to “completed” in user interface 425.

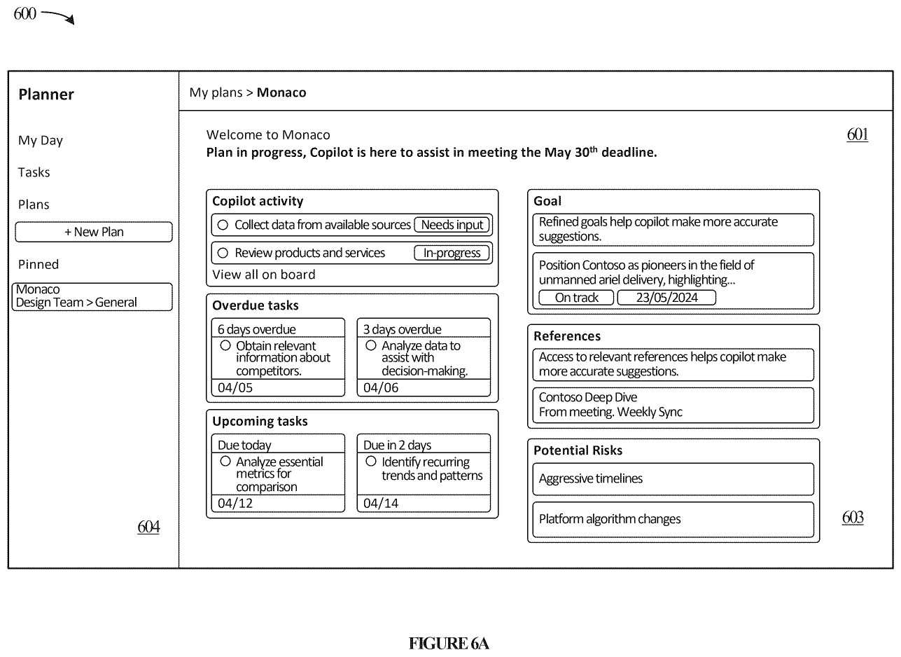

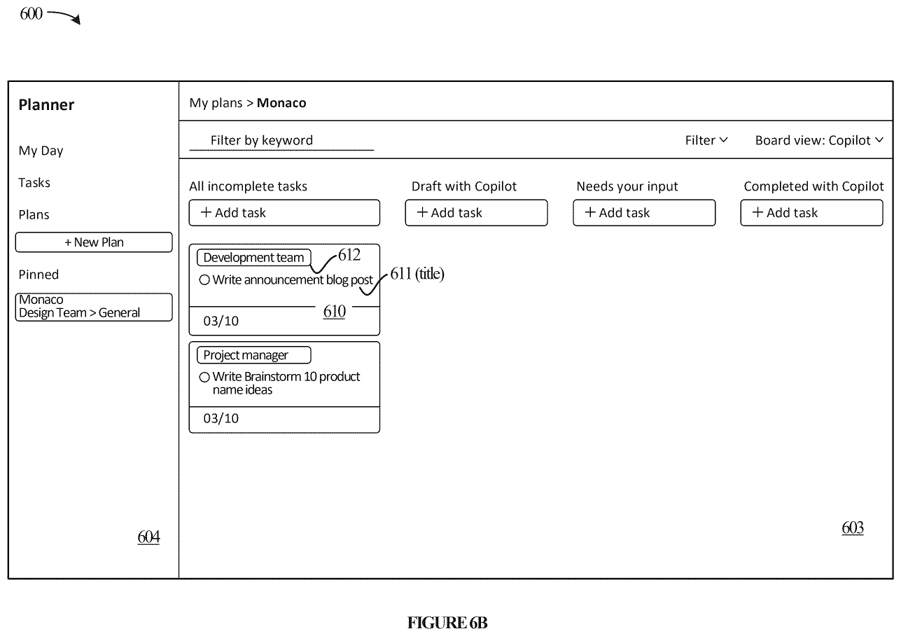

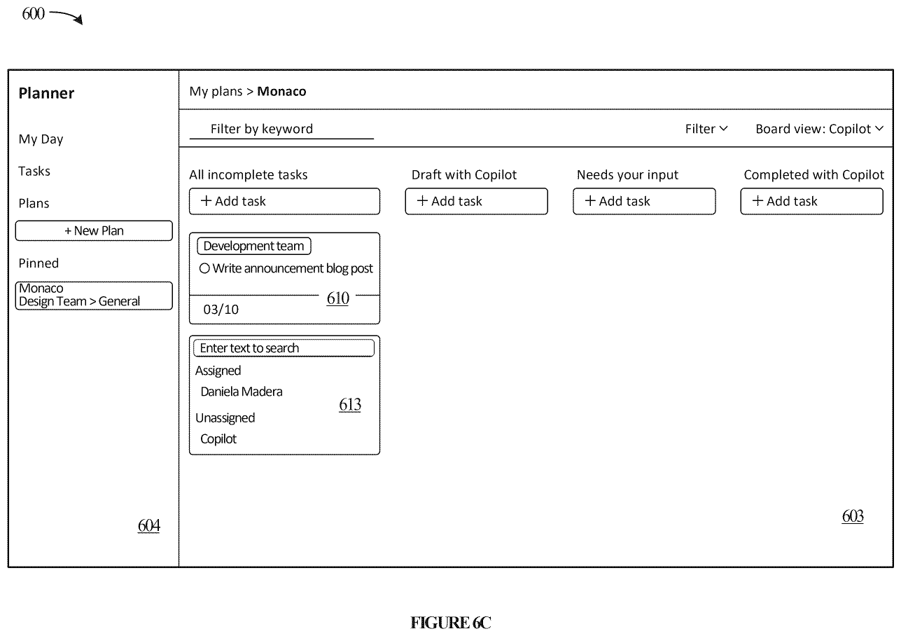

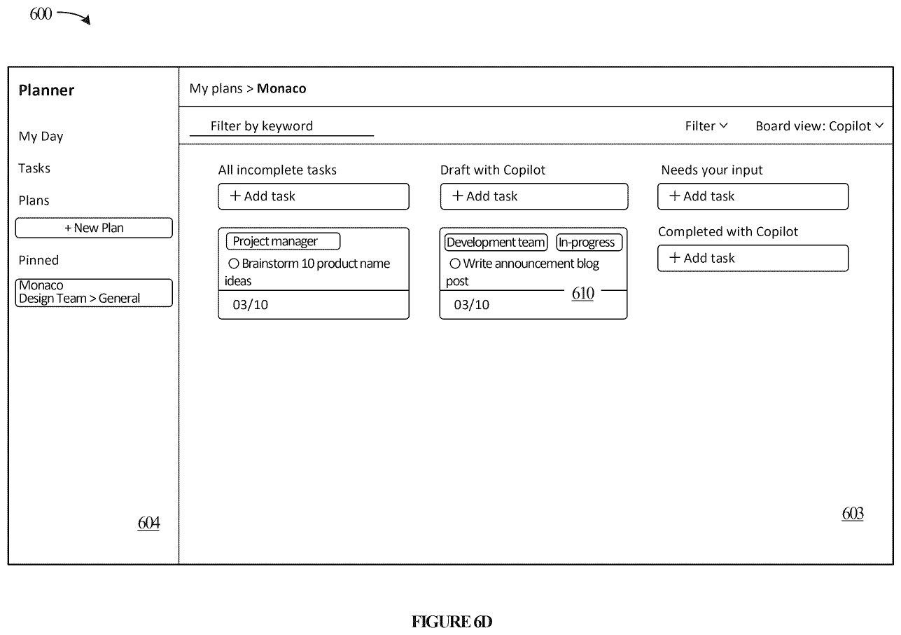

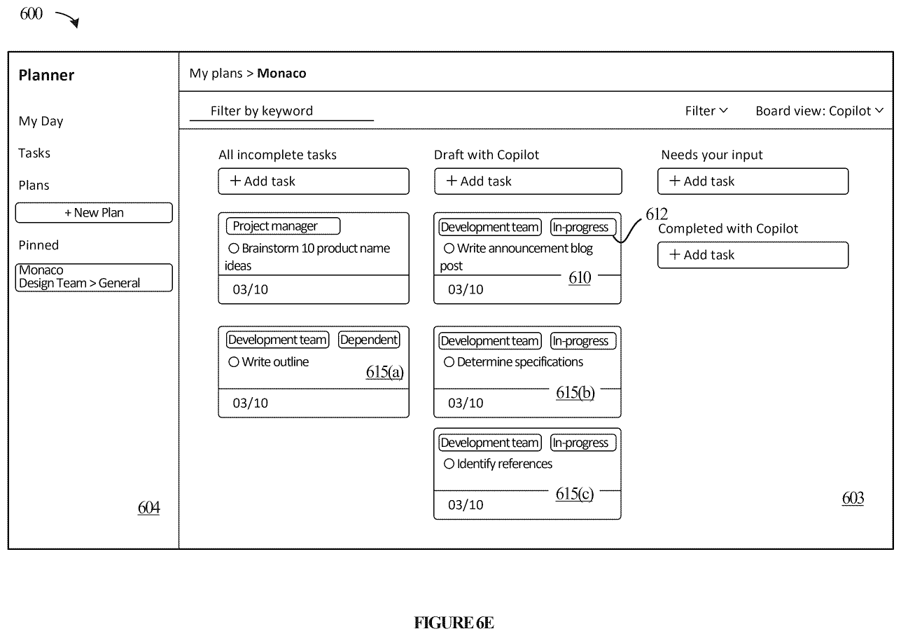

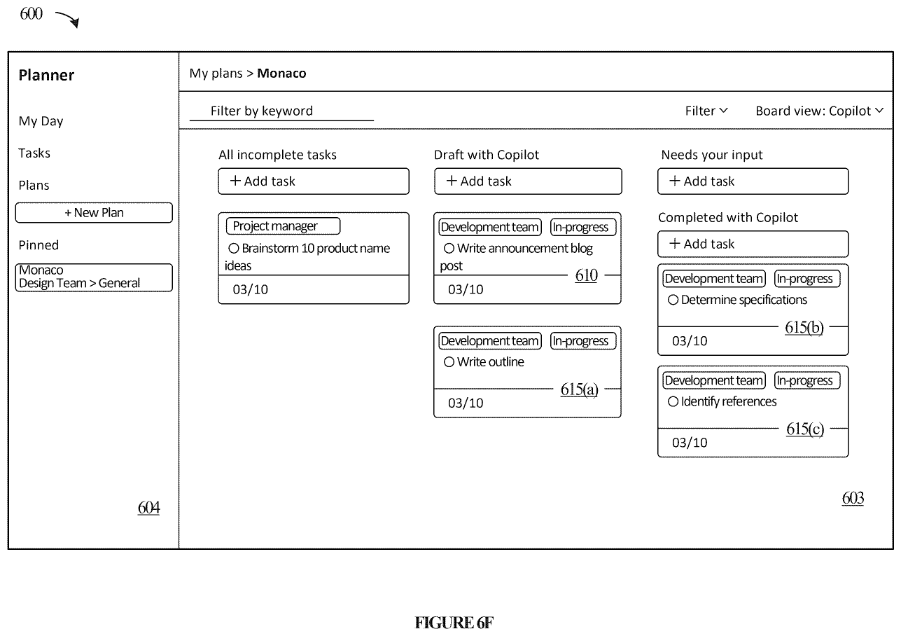

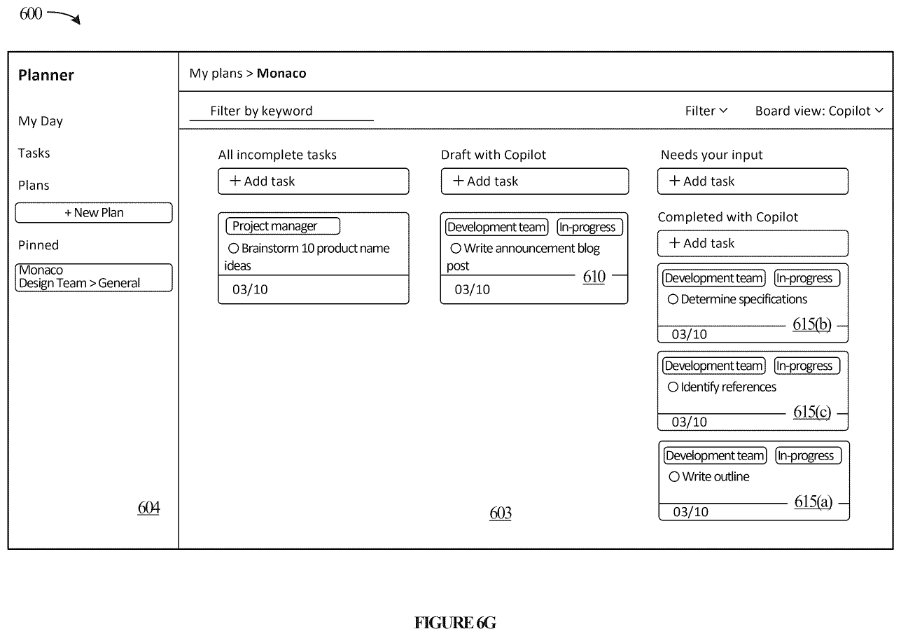

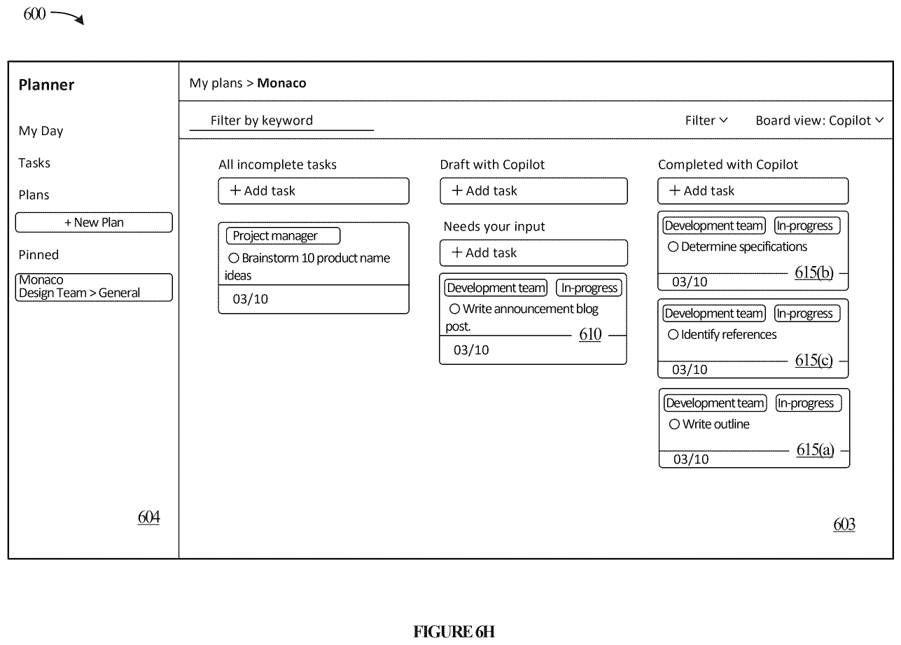

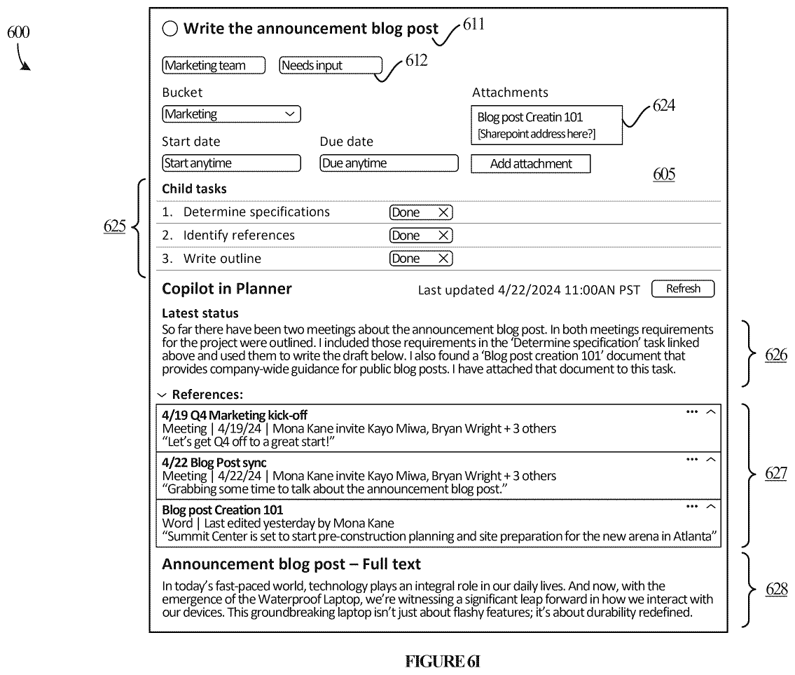

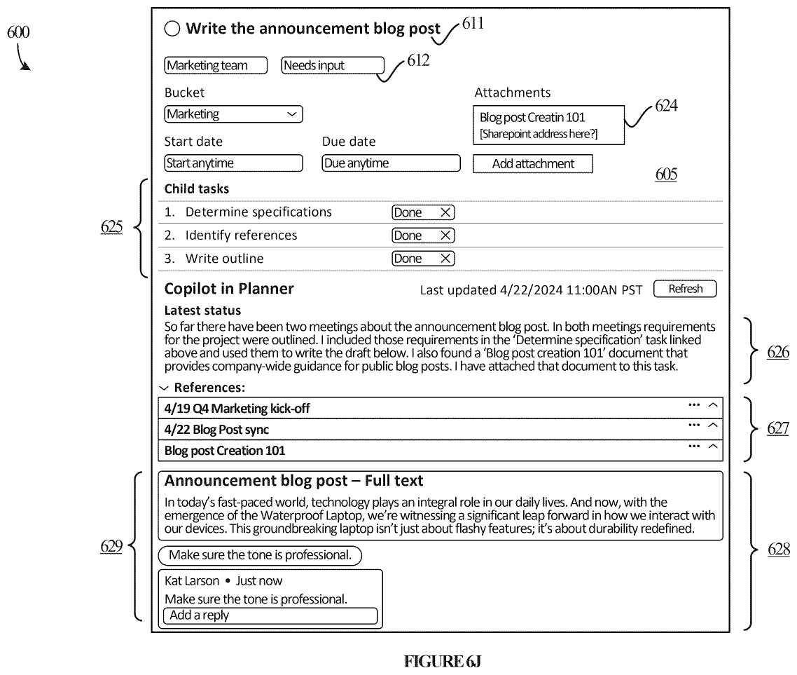

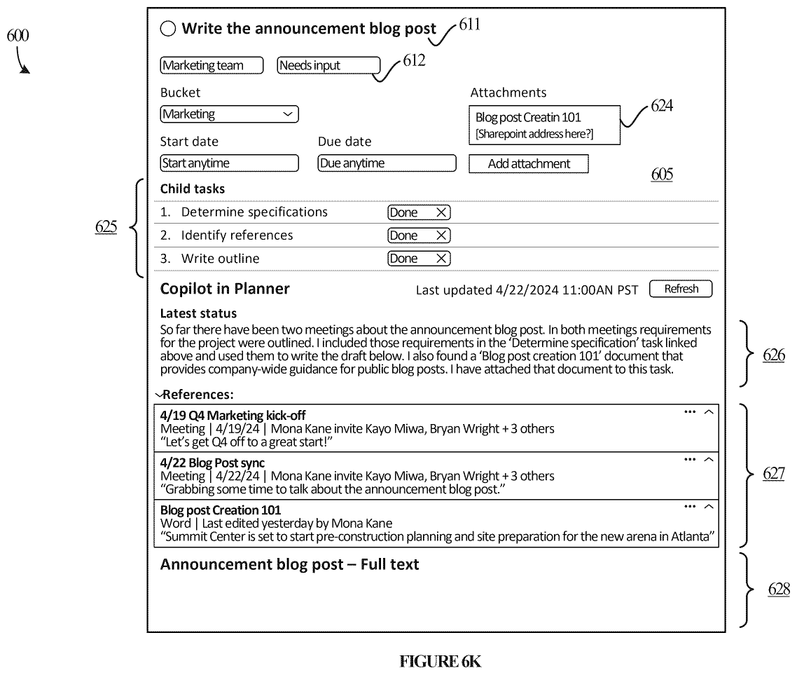

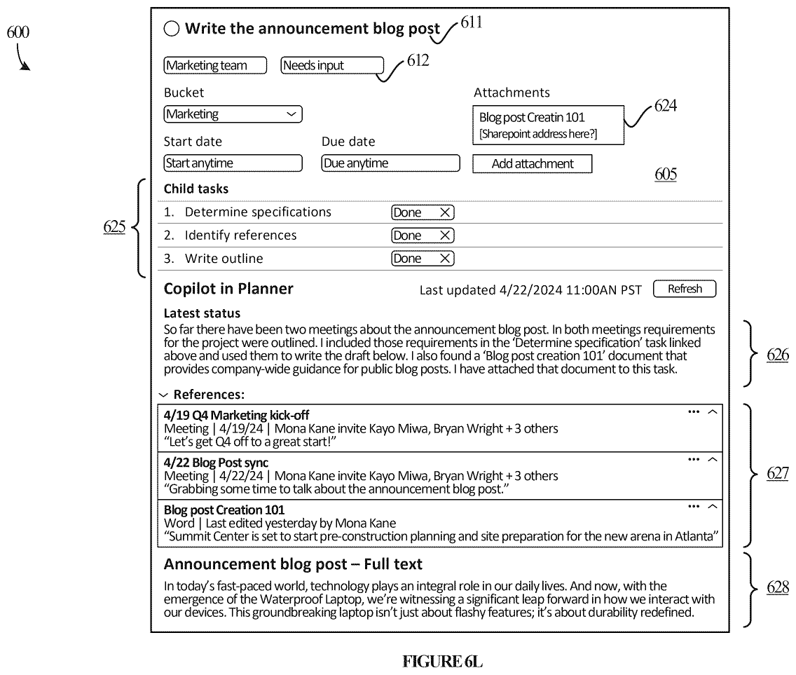

FIGS. 6A-6L illustrate user experience 600 in various stages of operation for multi-agent task management via a generative AI integration in an implementation. In user experience 600, a project planning application (“Planner”) hosts or calls an application assistant (“Copilot”) which manages tasks including orchestrating activities of multiple agents for completing the tasks via generative AI, such as an LLM.

FIG. 6A illustrates home page 601 of the project planning application hosting a project (“Monaco”) including multiple tasks. On home page 601, project information is displayed including the status and other information of various project tasks such as tasks assigned to the application assistant, overdue tasks, upcoming tasks, and so on. In various implementations of the technology disclosed herein, tasks may be defined by a user or by the application assistant. Tasks may also be assigned by users to other users (or to themselves) or to the application assistant, and the application assistant may assign itself a task. In some implementations, the application assistant may assign a task to a (human) user. As the tasks are defined, worked on, or completed, the statuses of the tasks are updated on home page 601 according to information received from the application assistant or from a user.

FIGS. 6B-6H illustrate user experience 600 in task dashboard 603 of the project planning application demonstrating task management and AI-orchestrated completion of task 610. In task dashboard 603, the tasks of the project are organized according to status: incomplete tasks, tasks assigned to the application assistant, tasks which are awaiting user input, and completed tasks. As illustrated in FIG. 6B, user experience 600 displays two graphical task cards corresponding to two project tasks the status of which is “incomplete.” Task status information may be updated by the application based on information received from the application assistant as the task is handled by the application assistant or from a user, e.g., when the user defines a task, assigns a task, or approves completion of task. User experience 600 also includes project management pane 604 by which a user can access a project, tasks assigned to the user, and other project planning information specific to the user.

To define a task for the project, the user or the application assistant may specify attributes such as a task title, a task description, tags and one or more assignees. As illustrated in FIG. 6B, task 610 has been defined to include title 611, tag(s) 612, and assignee(s) 613. The definition of a task may also include other information such as due dates, priority levels, relationships to other tasks, attachments or references, and so on. The task definitions may also include project-level information such as project goals, important dates, team members, organizational information, and so on.

Continuing with user experience 600, in FIG. 6C, the user assigns task 610 to the application assistant (“Copilot”) in dropdown menu 614. In an implementation, when a task is assigned to an application assistant, the application assistant receives the task definition from the application and initiates execution of an orchestration layer for managing the task to completion. The orchestration layer includes multiple agents, including task management agents and execution agents which elicit output from a generative AI model, such as an LLM, to complete the task. As illustrated in FIG. 6D, when the application sends the task to the application assistant, the application updates the task status to “in-progress” and moves the task card for task 610 to the column “Draft with Copilot” in task dashboard 603.

In an implementation, when the orchestration layer is executed for a given task, the task is evaluated by a complexity agent which evaluates the complexity of the task. In some scenarios, the complexity agent may prompt the LLM to estimate how long it would take a human to perform the task, and if the estimate time exceeds a threshold value, to return an indication that the task qualifies to be divided up into multiple simpler child tasks, the completion of which will be used in completing the task, now a parent task. For example, if the LLM estimates that a task will take three hours for a human to complete and the threshold value is set to two hours, the LLM is instructed by the complexity agent to return an indication that two or more child tasks should be defined and executed in order for the task to be completed. When the orchestration layer receives an indication that the task is to be subdivided, the orchestration layer may call a subtask agent which prompts the LLM to define a set of child tasks. The subtask agent may instruct the LLM to define the child tasks as tasks to be completed in order for the parent task to be completed in view of the task description and other contextual information. The attributes of the child tasks may be specified to include task continuity information, such as an indication that the completion of the parent task depends on the completion of the child tasks, and one or more assignees. For example, the child tasks may be assigned to the application assistant, although in some cases, the LLM may suggest assignment of a child task to a user. The task description attributes of the child tasks may also include information describing the provenance or history of the tasks (e.g., how or why the tasks were created and by whom, what work has been performed in completing the tasks). The subtask agent may specify that the LLM is to define the attributes of the child tasks in a parse-able format, such as a JSON object.

Upon receiving the output from the LLM, the orchestration layer may send the newly defined child tasks to the project planning application for display in the form of task cards in the user interface, e.g., task dashboard 603. As was done with the parent task, when a child task is assigned to the application assistant, the project planning application executes a call to the orchestration layer to manage completion of the child task.

As illustrated in FIG. 6E, three new tasks have been created for the project based on a complexity agent of the orchestration layer of the application assistant determining that task 610 is of sufficient complexity for subdividing. Based on that determination, a subtask agent was called by the orchestration layer resulting in child tasks 615(a)-(c) being created. The application assistant returns to the application the task definitions associated with child tasks 615(a)-(c), and the application updates task dashboard 603 to show the newly defined tasks along with their statuses. In the exemplary scenario, the output generated by the LLM in response to the subtask agent includes subtasks to “Determine specifications,” “Identify references,” and “Write outline.” In tasking the LLM to define new child tasks, the subtask agent in various implementations instructs the LLM to generate task descriptions and other task attributes as well as other contextual information by which the task is to be completed.

Among the attributes defined by the LLM for child tasks 615(a)-(c) are assignments and dependencies. Here, child tasks 615(b) and 615(c) are assigned to the application assistant for completion, while child task 615(a) depends on completion of those tasks. When the application assistant is called by the application to execute a given child task of child tasks 615(a)-(c), the orchestration layer will perform the same workflow for task completion as is in-progress for parent task 610. For example, the orchestration layer will call the complexity agent to determine if the given child task should be subdivided, then call an assignment agent to identify an execution agent for the child task, then call the assigned execution agent to perform the child task (e.g., elicit output from the LLM in accordance with the task description), and so on. In FIG. 6E, the project planning application updates the status of child tasks 615(b) and 615(c) to “in-progress” when the application calls the application assistant to complete those tasks. The status of child task 615(a) is “incomplete,” pending completion of the other two child tasks.

Continuing with FIG. 6F, when child tasks 615(b) and 615(c) are completed, user experience 600 is updated by the project planning application by moving the corresponding task cards of child tasks 615(b) and 615(c) to the “completed” column. The project planning application also calls the application assistant to begin executing child task 615(a); in doing so, the status of child task 615(a) is updated to “in-progress” as indicated by the status tag of the corresponding task card. When the application assistant is called to complete child tasks 615(a)-(c), the orchestration layer accesses continuity attributes of the tasks to supply contextual information to agents prompting the LLM. For example, because child task 615(a) has been defined to depend from child tasks 615(b) and 615(c), any generated content, task descriptions, and other contextual information of those other child tasks and of parent task 610 is included with the contextual information of child task 615(a) in prompts to the LLM.

FIG. 6G illustrates user experience 600 as updated by the project planning application when child task 615(a) is completed. With the child tasks of task 610 completed, completion of task 610 by the orchestration layer continues. Prompts by the various agents called to complete task 610 include generated content, task descriptions, and other contextual information of child tasks 615(a)-(c) in accordance with the determination to subdivide the task. FIG. 6H illustrates user experience 600 with the status of task 610 updated to “needs input.” FIGS. 6I-6L continue user experience 600 including receiving user review and approval of task 610.

FIGS. 6I-6L illustrate user experience 600 including task view 605 of task 610 in an implementation. Task view 605 may be displayed in the user interface of the project planning application, such as overlaying task dashboard 603, when a user selects or double-clicks the task card for task 610. As illustrated in FIG. 6I, task view 605 is populated with various attributes of task 610, such as title 611 and tag(s) 612. Other attributes represented in task view 605 include document 624, task continuity data 625, task history 626, references 627, and generated content 628. Task continuity data 625 includes the parent/child or other relationships of task 610 to other tasks along with status information for those tasks.

References 627 include event data, files, and other types of information supplied by a user or discovered by the application assistant which may be relevant to the task. For example, a calendar agent of the orchestration layer may search project scheduling information for events relating to the task. For example, the calendar agent may prompt the LLM with searching project scheduling information to identify events and event attributes relating to the task. As illustrated, the LLM may be further prompted to return comments, feedback, or other text from the project scheduling information which may be related to the task. Similarly, a file search agent of the orchestration layer may search project files or file repositories for documents which may be task-related. As illustrated, the application assistant has added found and added document 624 as being potentially relevant to completing task 610. When prompting the LLM to generate content for task 610, the content of document 624 may be included.

Task history 625 includes a natural language summary of task-related events generated by the LLM. For example, when the orchestration layer initiates execution of task 610 (e.g., when task 610 is assigned to the application assistant) or when the orchestration layer calls various agents to work on or complete task 610, the orchestration layer may call a status agent to provide and update a summary of what actions have been performed with respect to completing the task along with which information may be have been referenced in performing those actions.

Generated content 628 is generated by the LLM in response to a prompt by an execution agent. In an implementation, when the orchestration layer executes a workflow to complete task 610, an assignment agent tasks the LLM with selecting an execution agent for generating content to complete the task. The selected execution agent prompts the LLM to generate content in accordance with the various task attributes and other contextual information. Upon receiving the generated content, the orchestration layer may call one or more review agents to review the generated content in light of the task description and other contextual information. Should the review agent deem that the generated content falls short of answering of the task description, the review agent alerts the orchestration layer which resubmits task 610, along with feedback from the review agent, to regenerate the content. In this way, the orchestration layer mediates a dialogue between the execution agent and the review agent by which content is generated and refined. When the review agent deems the generated content to be satisfactory, the application assistant returns task 610 to the application for further handling. In various implementations, the orchestration layer monitors the conversation between the execution agent and the review agent to ensure that the back-and-forth is not prolonged.

Continuing with FIG. 6J, the user has added comment 629 comprising an instruction for revising generated content 628. Upon receiving comment 629, the project planning application may await feedback from other users before resubmitting task 610 to the application assistant for revision, or the user may cause task 610 to be immediately resubmitted (e.g., by selecting the “Refresh” button) to generated updated content. In either case, when the application assistant receives task 610 with comment 629, the orchestration layer re-executes the workflow for completing task 610, which now includes revising generated content 628. When revised content has been received, the application assistant returns updated task information to the application which again updates the status of task 610 to “needs input” in task dashboard 603. The user is thus made aware that new content is available for review.

FIG. 6K illustrates task view 605 of task 610 including updated content for task history 626 and for generated content 628. In task history 626, information is added which indicates that “[a]dditional feedback was found in comments of the previous draft and has been incorporated.” For example, the user may approve the revised content by moving the task card of task 610 to the Completed column of task dashboard 603. When the user has approved the content, the project planning application updates the status of task 610 to show that it is completed, as illustrated in tag(s) 612 of FIG. 6L.

FIGS. 7A-7C illustrate prompt templates of agents of a system for multi-agent task completion via a generative AI model integration in an implementation. In an exemplary scenario, an orchestration layer of an application assistant or task manager receives a task assigned for completion via a generative AI integration and initiates a task completion workflow. The task completion workflow includes calling a breakdown agent (e.g., a task management agent for dividing the task) to determine whether the task should be divided into simpler subtasks to be completed by various execution agents. In calling the breakdown agent, a prompt based on prompt template 700 is populated with attributes of the task and transmitted to a generative AI model to elicit a determination and, if appropriate, subtasks for completing the task.

Prompt template 700 of FIG. 7A includes a script which tasks a generative AI model with determining whether a task should be broken down into a list of steps to be taken to complete the task based on whether the task will take longer than a specified amount of time (e.g., two hours) to perform. When the model determines that a task should be broken down into steps, the prompt tasks the generative AI model with returning the list of steps in a specified order and including a validation by which the individual steps can be confirmed for completion, for example, by a completion review agent. The prompt also specifies an output format for subtasks for each of the steps including task attributes to be defined by the model. Upon receiving output generated by the generative AI model based on prompt 700, the application hosting the task creates the subtasks and displays them in a user interface of the application. The application or application assistant may also update a continuity attribute of the task to indicate that subtasks have been defined for the task and for tracking the status of the subtasks. The orchestration layer executing the task completion workflow may access the continuity attribute in controlling the completion workflow of the task (e.g., pausing the workflow to obtain content from subtasks). In the event that the model determines that the task should not be broken down, the prompt returns an indication which causes the orchestration layer to call the next agent in the task completion workflow.

Continuing the exemplary scenario described above, when the task has been received by the orchestration layer of the application assistant or task manager, the orchestration layer may call a task management agent to select an execution agent for the task. Prompt template 710 of FIG. 7B includes a script of an assignment agent which tasks a generative AI model with selecting an execution agent (“assignee”) for completing a task. In prompt template 710, the model is tasked with selecting an assignee from among of a list of assignees along with their skill set. In various implementations, the roster of execution agents supplied to the model in prompt template 710 includes a stock set of agents for performing common content-generation activities (e.g., writing a blog post, generating advertising copy, evaluating writing for a particular audience) but may include agents tailored for completing highly specialized tasks. In its output, the model returns a selected agent to which the orchestration layer sends the task for completion.

In an implementation, although the assignment agent may include a roster of execution agents to which the task can be assigned, the assignment agent may also include lists of human users, such as team members, to which the task may be assigned. For example, the prompt may include information relating to the users' skill sets, experience, or areas of expertise, and the model may be tasked with assigning or recommending one or more human users for completing a task.

When the assigned execution agent returns output for completing the task, the orchestration layer may call a task management agent for reviewing AI-generated content to evaluate the content before it is presented to the user. Prompt template 720 of FIG. 7C includes a script of a completion review agent which tasks a generative AI model with reviewing the content generated by an execution agent for completeness or sufficiency with respect to an assigned task. In an implementation, the task definition may include a validation attribute or criteria by which the output is to be evaluated. When the completion review agent is called, a prompt based on prompt template 720 is populated with information such as the task description, the content generated by the assigned execution agent, and task validation criteria. The prompt tasks the model with returning its evaluation including an indication that the output completes the task or that the output should be revised in a particular manner. When the review agent determines that the content should be revised, the orchestration layer mediates a dialogue between the review agent and the execution agent in which the execution agent revises the content based on the comments from the review agent, and the review agent evaluates the revised content. The back-and-forth between the execution agent and the review agent continues until the review agent indicates that the content is satisfactory or until a maximum number of conversational turns is reached.

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements task management process 806, which is (are) representative of the task management processes discussed with respect to the preceding Figures, such as processes 200 and 210 and workflows 300 and 500. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including task management process 806) may be implemented in program instructions and among other functions may, when executed by processing system 802, direct processing system 802 to operate as described with respect to the various operational scenarios, sequences, and processes illustrated herein. For example, software 805 may include program instructions for implementing a multi-agent task management process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support multi-agent task management guided by generative AI in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
determine that a task has been assigned to an application assistant of an application, wherein the application assistant includes multiple agents which interact with a generative artificial intelligence (AI) model;
orchestrate the agents in their interactions with the generative AI model in furtherance of completing the task; and
update contextual information of the task based on the interactions.

2. The computing apparatus of claim 1, wherein the multiple agents comprise task management agents including rules which task the generative AI model with generating content by which to execute a workflow for completing the task and execution agents including rules which task the generative AI model with generating content to complete the task.

3. The computing apparatus of claim 2, wherein to orchestrate the agents in their interactions with the generative AI model in furtherance of completing of the task, the program instructions direct the computing apparatus to:
determine whether subtasks may be created based on the task;
assign an execution agent of the execution agents to execute the task; and
evaluate the content generated by the generative AI model based on a call by the application assistant to the assigned execution agent.

4. The computing apparatus of claim 3, wherein the program instructions further direct the computing apparatus to create the subtasks based on a complexity metric of the task, wherein the complexity metric is generated by the generative AI model based on a call by the application assistant to a breakdown agent.

5. The computing apparatus of claim 4, wherein the complexity metric comprises an estimate of a time to complete the task.

6. The computing apparatus of claim 3, wherein the program instructions further direct the computing apparatus to create the subtasks in a user interface of the application based on subtask definitions generated by the generative AI model and assigning the subtasks to the application assistant for completion.

7. The computing apparatus of claim 3, wherein to evaluate the content generated by the generative AI model, the program instructions direct the computing apparatus to mediate a dialogue between a completion review agent and the assigned execution agent.

8. The computing apparatus of claim 1, wherein to orchestrate the agents in their interactions with the generative AI model in furtherance of completing the task, the program instructions direct the computing apparatus to submit a prompt of an agent of the agents to the generative AI model to elicit output which advances a completion workflow.

9. The computing apparatus of claim 1, wherein the program instructions further direct the computing apparatus to update a user interface of the application to reflect a status of the task.

10. A method of operating a computing device comprising:
determining that a task has been assigned to an application assistant of an application, wherein the application assistant includes multiple agents which interact with a generative artificial intelligence (AI) model;
orchestrating the agents in their interactions with the generative AI model in furtherance of completing the task; and
updating contextual information of the task based on the interactions.

11. The method of claim 10, wherein the multiple agents comprise task management agents including rules which task the generative AI model with generating content by which to execute a workflow for completing the task and execution agents including rules which task the generative AI model with generating content to complete the task.

12. The method of claim 11, wherein orchestrating the agents in their interactions with the generative AI model in furtherance of completing of the task comprises:
determining whether subtasks may be created based on the task;
assigning an execution agent of the execution agents to execute the task; and
evaluating the content generated by the generative AI model based on a call by the application assistant to the assigned execution agent.

13. The method of claim 12, further comprising creating the subtasks based on a complexity metric of the task, wherein the complexity metric is generated by the generative AI model based on a call by the application assistant to a breakdown agent.

14. The method of claim 13, wherein the complexity metric comprises an estimate of a time to complete the task.

15. The method of claim 12, further comprising creating the subtasks in a user interface of the application based on subtask definitions generated by the generative AI model and assigning the subtasks to the application assistant for completion.

16. The method of claim 12, wherein evaluating the content generated by the generative AI model comprises mediating a dialogue between a completion review agent and the assigned execution agent.

17. The method of claim 10, wherein orchestrating the agents in their interactions with the generative AI model in furtherance of completing the task comprises submitting a prompt of an agent of the agents to the generative AI model to elicit output which advances a completion workflow.

18. One or more computer readable storage media having program instructions stored thereon that, when executed by one or more processors, direct a computing apparatus to at least:
determine that a task has been assigned to an application assistant of an application, wherein the application assistant includes multiple agents which interact with a generative artificial intelligence (AI) model;
orchestrate the agents in their interactions with the generative AI model in furtherance of completing the task; and
update contextual information of the task based on the interactions.

19. The one or more computer readable storage media of claim 18, wherein the multiple agents comprise task management agents including rules which task the generative AI model with generating content by which to execute a workflow for completing the task and execution agents including rules which task the generative AI model with generating content to complete the task.

20. The one or more computer readable storage media of claim 19, wherein to orchestrate the agents in their interactions with the generative AI model in furtherance of completing of the task, the program instructions direct the computing apparatus to:
determine whether subtasks may be created based on the task;
assign an execution agent of the execution agents to execute the task; and
evaluate the content generated by the generative AI model based on a call by the application assistant to the assigned execution agent.
